(19) United States
(12) Patent Application Publication
(10) Pub. No.: US 2003/0063336 A1
(43) Pub. Date: Apr. 3, 2003

(54) Image scanning apparatus with cross-shaped document passage

(76) Inventor: Chin-Fu Cho, Taipei (TW)

Correspondence Address: NIXON PEABODY, LLP, 8180 GREENSBORO DRIVE, SUITE 800, MCLEAN, VA, 22102, US

(21) Appl. No.: 10/043,308

(22) Filed: Jan. 14, 2002

(30) Foreign Application Priority Data
Oct. 3, 2001 (TW) 090216810

(51) Int. Cl. H04N 1/04

(52) U.S. Cl. 358/498

(57) ABSTRACT

The present invention provides an image scanning apparatus, which can scan either a simplex or a duplex document. The image scanning apparatus, having a processor, includes a paper tray for placing a document with a first side and a second side, a cross-shaped document passage, a drive module for driving the document to pass through the cross-shaped document passage in response to a trigger, and a scan module having a light source for scanning the document passing through the cross-shaped document passage. Users are able to choose to scan either in a simplex scanning mode when processing a simplex document or in a duplex scanning mode when processing a duplex document.

### BACKGROUND OF THE INVENTION

1. Field of the Invention

The present invention relates to an image scanning apparatus and, more specifically, to an image scanning apparatus with a cross-shaped document passage and a single scan module for scanning either in a simplex scanning mode or in a duplex scanning mode.

2. Description of the Related Arts

The demand for multimedia information has become remarkable with the recent development of information technology. Therefore, images usually appear in documents, which in the past included only text information. In order to satisfy the demand for large amounts of image data, a scanner is generally utilized as an input device. The scanner has recently become one of the most popular image retrieval systems because of its performance and price.

An automatic document feeder (ADF) is extensively used in current scanners to automatically and sequentially feed a plurality of documents to a scan module. A document is illuminated for the scan module to read the image thereon. When using scanner, among others, it is necessary to avoid jamming of documents. Consequently, there must be a simple and unrestricted document passage in the scanner.

In the prior art, there are two types of automatic document feeder (ADF) with respect to the document passage. The first type is the straight path and the other type is the U-turn path. In general, the straight path type ADF serves better for documents of different thickness due to thicker document often encounters jamming issues when the U-turn path type ADF is employed. Nevertheless, scanner with the straight path type ADF requires almost twice as large as scanner with the U-turn passage type ADF does. While deploying a single scan module, both the straight path type and the U-turn path type scanners are able to perform only the simplex scanning mode. It is required to use at least two scan modules to perform a duplex scanning mode. That is the reason why the size of the scanner with the duplex scanning mode becomes huger and its cost becomes higher. Accordingly, since the scanner capable of performing the duplex scanning mode requires larger space and higher cost, typical users do not favor it.

Currently, none of the conventional straight path type or the U-turn path type scanners is able to perform the duplex scanning mode by single scan module. Therefore, demands have arisen for scanner capable of operating in either simplex scanning mode or duplex scanning mode through a single scan module.

### SUMMARY OF THE INVENTION

The present invention provides an image scanning apparatus capable of operating in either simplex scanning mode or duplex scanning mode by incorporating a single scan module and a cross-shaped document passage. Users do not have to flip document over to scan both sides of document.

The image scanning apparatus with a processor therein includes a paper tray, a cross-shaped document passage, a drive module, and a scan module. The paper tray is used for placing a document having a first side and a second side. The cross-shaped document passage has an overlap portion. The drive module drives the document to pass through the cross-shaped document passage in response to a trigger. The scan module scans the document passing through the cross-shaped document passage.

Users are able to select a simplex scanning mode for scanning a simplex document or a duplex scanning mode for scanning a duplex document.

Additional objects and advantages of the invention will be set forth in the description which follows, and in part will be obvious from the description, or may be learned by practice of the invention. The objects and advantages of the present invention may be realized and obtained by means of the instrumentalities and combinations of particulars pointed out in the appended claims.

### BRIEF DESCRIPTION OF THE DRAWINGS

FIG. 1a shows a schematic diagram of an embodiment of the image scanning apparatus of the present invention;

FIG. 1b shows a schematic diagram of the drive module of an embodiment of the image scanning apparatus of the present invention;

FIG. 1c shows a schematic diagram of the scan module of an embodiment of the image scanning apparatus of the present invention;

FIG. 2 shows how the first side of the document is scanned by the image scanning apparatus of the present invention; and

FIG. 3 shows how the second side of the document is scanned by the image scanning apparatus of the present invention.

### DETAILED DESCRIPTION OF THE INVENTION

The present invention provides an image scanning apparatus capable of operating in either simplex scanning mode or duplex scanning mode by incorporating a cross-shaped document passage 2 and a single scan module 4.

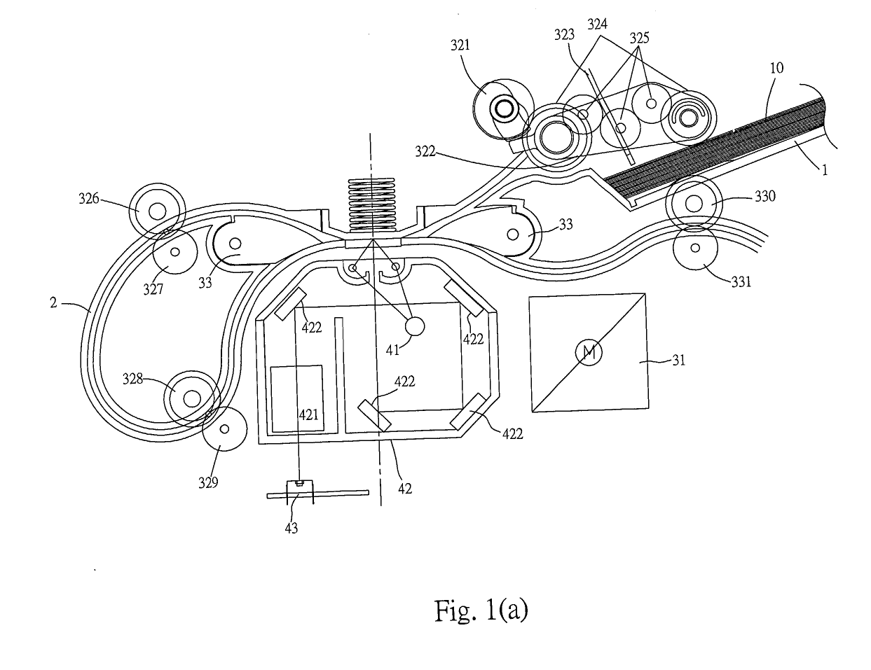

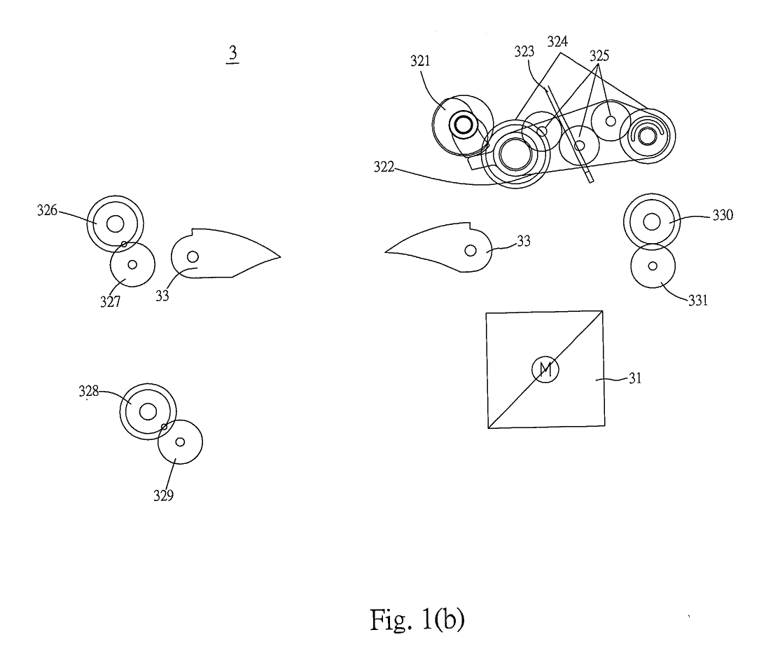

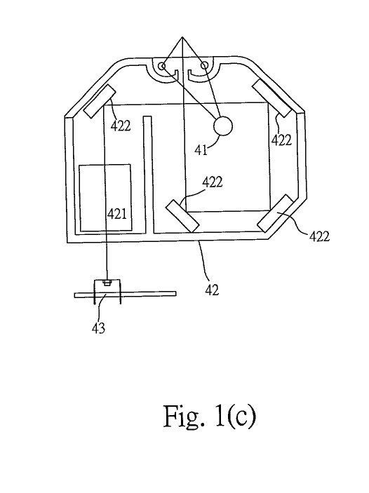

Please refer to FIG. 1a, FIG. 1b, and FIG. 1c. The image scanning apparatus, with a processor therein, includes a paper tray 1, a α-shaped document passage 2, a drive module 3, and a scan module 4. Users are able to choose to scan either in a simplex scanning mode when processing a simplex document or in a duplex scanning mode when processing a duplex document.

As shown in FIG. 1a, the paper tray 1 is used for placing a document 10. The document 10 has a first side and a second side. The α-shaped document passage 2 has an overlap portion.

As shown in FIG. 1a and FIG. 1b, the drive module 3 drives the document 10 to pass through the α-shaped document passage 2 in response to a trigger. The drive module 3 includes a motor 31, a roller assembly, a valve set 33, and a sensor (not shown).

The valve set 33 controls the document 10 to undergo scans of the first side and the second side consecutively.

The sensor (not shown) informs the processor to control the valve set 33 in response to the position of the document 10.

The roller assembly, driven by the motor 31, conveys the document 10 to move along the α-shaped document passage 2. The roller assembly includes active rollers 324, 326, 328, 330, passive rollers 325, 327, 329, 331, a cam set 321, a pick-up arm 322, and an adjustment plate 323.

The active rollers 324, 326, 328, 330 and passive rollers 325, 327, 329, 331, convey the document 10 to pass through the α-shaped document passage 2 in response to the drive of the motor 31.

The pick-up arm 322 supports and connects the active roller 324 and the passive roller 325.

The cam set 321 coordinates the document feeding operation of the pick-up arm 322, the active roller 324, and the passive roller 325.

As shown in FIG. 1a and FIG. 1c, the scan module 4 scans the document 10 passing through the α-shaped document passage 2. The scan module 4 includes a lamp 41, an optical scanning device 42, and a charge-coupled device (CCD) 43.

The light source 41 is operative to provide a light to illuminate the document 10 passing through the scan module 4 to generate a first signal.

The optical scanning device 42, including a lens 421 and at least a reflector 422, reflects the first signal and focuses the first signal reflected to output a second signal.

The charge-coupled device (CCD) 43 receives the second signal to generate an electric signal.

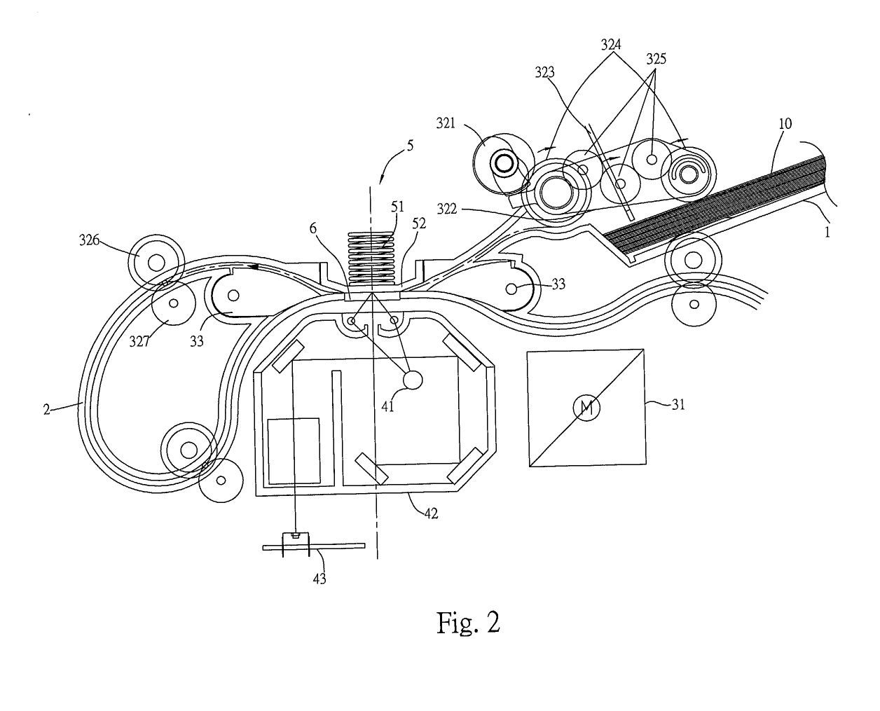

Please refer to FIG. 2. Before scanning the document 10, at first, users have to make a decision of selecting either the simplex scanning mode or the duplex scanning mode. The document 10 is put on the paper tray 1. The cam set 321 coordinates the document feeding operation, by the pick-up arm 322 and the adjustment plate 323, and proceeds with feeding the document 10 by the active roller 324 and the passive roller 325.

By means of the power driven by the motor 31, the active roller 324 made by rubber conveys the document 10 counterclockwise to move along the α-shaped document passage 2.

The document 10 is allowed to pass through a pressing member 5 and a platform 6 along the α-shaped document passage 2 because of the downward status of the valve set 33. There are a spring 51 and a flat plate 52 in the pressing member 5 corresponding to the overlap portion of the α-shaped document passage 2. When the document 10 smoothly goes through the platform 6, the spring 51 and the flat plate 52 in the pressing member 5 keep pressing the document 10 evenly. The platform 6 is made by glass, and the center point of the platform 6 is aligned with the lens 421.

The platform 6 corresponds to the overlap portion of the α-shaped document passage 2. When the document 10 passes through the platform 6, the scan module 4 starts to operate by way of illuminating with a light source 41 to generate a first signal. The first signal is reflected and then to be focused to output a second signal. The charge-coupled device (CCD) 43 receives the second signal and generates an electric signal. Accordingly, the scanning process of the first side of the document 10 is accomplished. At this time, the document 10 moves forward to an entrance between the active roller 327 and the passive roller 326.

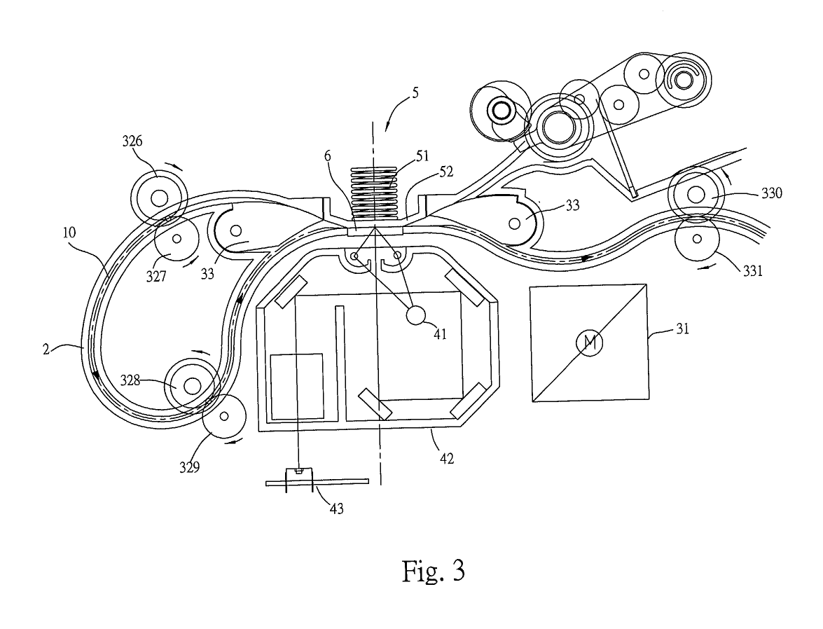

Please refer to FIG. 3. After the scanning process of the first side of the document 10 mentioned above, the document 10 enters the entrance between the active roller 327 and the passive roller 326. The power from the motor 31 enables the active roller 327 and the passive roller 326 to keep conveying the document 10 forward counterclockwise.

After the document 10 passes through a loop-shaped portion of the α-shaped document passage 2, the document 10 is ready to be scanned for the second side of the document 10. There is a sensor (not shown) around the active roller 328 and the passive roller 329. The sensor informs the processor to operate the valve set 33 in response to a trigger of the passing document 10 to the sensor. The valve set 33 is activated upward to form a new path to allow the document 10 to pass through the pressing member 5 and the platform 6 again.

If users choose the simplex scanning mode at the beginning, the scan module 4 will stop operating as the document 10 passing through new path. The power from the motor 31 directly exits the document 10 at location around the active roller 330 and the passive roller 331. Accordingly, the simplex scanning mode process is completed.

If users choose the duplex scanning mode at the beginning, the scan module 4 will operate as the document 10 passing through new path. The optical scanning device 42 reflects and focuses the light illuminating from the light source 41 again. The charge-coupled device (CCD) 43 receives the reflected signal to generate an electric signal. Afterwards, the power from the motor 31 exits the document 10 at the location around the active roller 330 and the passive roller 331. Accordingly, the duplex scanning mode process is completed.

In the foregoing specification the invention has been described with reference to specific embodiments. It will, however, be evident that various modification and changes may be made to thereto without departing from the broader spirit and scope of the invention. The specification and drawings are, accordingly, to be regarded in an illustrative rather than restrictive sense. Thus, it is intended that the present invention covers the modification and variations of this invention provided they come within the scope of the appended claims and their equivalents.

What is claimed is:

1. An image scanning apparatus having a processor, comprising:
a paper tray for placing a document having a first side and a second side;
a cross-shaped document passage having an overlap portion;
a drive module for driving said document to pass through said cross-shaped document passage in response to a trigger; and
a scan module for scanning said document passing through said cross-shaped document passage.

2. The image scanning apparatus according to claim 1, wherein said cross-shaped document passage is a α-shaped document passage.

3. The image scanning apparatus according to claim 1, wherein said drive module comprises:
a motor;
a roller assembly, driven by said motor, for conveying said document to move along said cross-shaped document passage;
a valve set for controlling said document to undergo scans of said first side and said second side consecutively; and
a sensor for informing said processor to control said valve set in response to a position of said document.

4. The image scanning apparatus according to claim 1, where said scan module comprises:
a light source for providing a light to said document passing through said scan module to generate a first signal;
an optical scanning device, including a lens and at least a reflector, for reflecting said first signal and focusing said first signal reflected to output a second signal; and
a charge-coupled device (CCD) for receiving said second signal to generate an electric signal.

5. The image scanning apparatus according to claim 3, where said roller assembly comprises:
at least an active roller for producing a friction to convey said document;
at least a passive roller for cooperating with said active roller to convey said document;
an adjustment plate for aligning a leading edge of said document;
a pick-up arm for fixing said active roller and said passive roller; and
a cam set for coordinating a document feeding operation between said pick-up arm, said active roller and said passive roller.

6. The image apparatus of claim 1, wherein said document is selected to scan either in a simplex scanning mode or in a duplex scanning mode.

7. The image apparatus of claim 4 further comprising:
a platform corresponding to said overlap portion of said cross-shaped document passage, said document is illuminated by said light to generate said first signal when said document passes through said platform.

8. The image apparatus of claim 7 further comprising:
a pressing member corresponding to said overlap portion of said cross-shaped document passage, said document is pressed evenly by said pressing member when said document passes through said platform.

9. The image apparatus of claim 8, wherein said pressing member further comprises a spring.

10. The image apparatus of claim 8, wherein said pressing member further comprises a flat plate.
